(19) United States
(12) Patent Application Publication
(10) Pub. No.: US 2014/0093651 A1
(43) Pub. Date: Apr. 3, 2014

(54) Repellent Surfacing Solutions and Mixtures for Treatment of Surfaces

(71) Applicants: Hristem Mitkov Dyanov, Carol Stream, IL (US); Paoula Hristemova Dyanova, Skokie, IL (US); Radu Chiorean, Carol Stream, IL (US)

(72) Inventors: Hristem Mitkov Dyanov, Carol Stream, IL (US); Paoula Hristemova Dyanova, Skokie, IL (US); Radu Chiorean, Carol Stream, IL (US)

(21) Appl. No.: 13/947,039

(22) Filed: Jul. 20, 2013

Related U.S. Application Data
(60) Provisional application No. 61/674,217, filed on Jul. 20, 2012.

(51) Int. Cl. C09K 3/22

(52) U.S. Cl. CPC C09K 3/22
USPC 427/515; 252/88.1; 556/465; 556/460; 427/387

(57) ABSTRACT

The invention describes methodological approach and process for preparation of variable compositions of water-(hydrophobic), oil- and dust-repellent multi-component mixtures containing non-cyclic silanes, siloxanes, hydrocarbons, silane-carbons), cyclic molecular compounds (cyclic-silanes, hydrocarbons, silane-carbons and their derivatives) and other hydrophobic molecular components (as separate molecular substances or as molecular substitutes within the silanes and/or the cyclic compound molecules). Such methodological approach offers best flexibility for repellant mixtures preparation in achieving highly repellant properties, durability and long-lasting (permanent) bonding for specific surface applications and for preparation of other subsequent types of repellant surfacing solutions such as paints or sealing agents, textiles and else.

### CROSS-REFERENCE TO RELATED APPLICATIONS

This application is claiming the priority benefit of the provisional patent application US-61/674,217 “Preparation of water-repellent hydrophobic solutions for treatment of surfaces and surfacing mixtures”.

### DESCRIPTION

### Terminology and Abbreviations Used

Halogen-substituted silane—means a silane molecule containing silicon (Si) atom(s) covalently bound with 1, 2, 3 or 4 of any of the halogen-elements from the Periodic Table of Chemical Elements such as Chlorine (Cl), Fluorine (F), Iodine (I) and Bromine (Br) at any particular single silicone atom—a minimum of one and more (up to all) silicon atom(s) may be bound to halogen atom(s). Within the description of this invention as required by the common chemical principles, a maximum of 4 halogen atoms are allowed to be covalently bound to each one silicone (Si) atom—therefore the total number of halogen-atoms within a silane molecule may be higher than 4; i.e. depending upon the total number of silicone or carbon atoms within the particular silane molecule of choice and the molecular structure of the molecule. The same requirements regarding the halogen substitutions are valid for the carbon atom within carbon-silanes, hydrocarbons and their chemical derivatives—i.e. halogenated carbons and halogenated carbon-silanes (carbo-silanes). Halogen-substituted silanes as defined by a broad meaning in this invention include also any other molecule containing at least one silicone (Si) atom and at least one Halogen atom in its molecular structure which atoms may be bound to any kind of atoms including any other than silicone and/or carbon.

Silane—by its broadest definition in general means any substance molecule containing at least one silicone (Si) atom. The description “silicones” for the whole class of polysiloxanes is an imitation of the oxygen-carbon bonds of carbon chemistry which are known as “ketones”. (The latter however, because of their particular characteristics, form double bonds instead of single bonds).

Organosilanes—by its definition in general the term within this invention is used mostly as a synonym of carbon-silanes—a group of carbon-element (C) containing chemical compounds that also comprise at least one Silicone (Si) atom in a particular compound's molecule; however by its broadest definition this group of chemical substances includes also any other silicone- and carbon-containing chemical that contains also the atoms of nitrogen (N), sulfur (S), phosphorus (P) and oxygen (O) that are commonly present in the biomolecules of organic origin.

Nanolayer and microlayer—The words “nano” and “micro” refer to the metric scale of measurements as defined by the international SI system—i.e. hano-meter and micro-meter. In more general meaning for the purpose of this invention description, the “nanolayer” and “microlayer” are used to as to refer to a very thin (ultra-thin) surface layer composed by molecular-size components—usually not exceeding microns-size thicknesses.

All chemical terminology used is according to the widest-possible meaning as accepted within the common chemical practice and terminology, and the international SI system.

### FIELD OF THE INVENTION

This invention relates to water-repellent (hydrophobic), oil-repellent and dust-(microparticle-) repellent coating compositions that have high application flexibility, relatively low toxicity, produces a highly durable solid coatings, and has an improved external appearance, curability and long-lasting properties achieved by a permanent-type bonding. More particularly, the invention relates to curing compositions useful as a finishing-type coating compositions for surface deposition such as motor vehicles and boat surfaces, glass surfaces, home appliances and surfaces, as well as additive compounds for paints, impregnating agents for cements, woods and porous materials in the building industry, in textile industry and other applicable fields including but not limited to biological objects, medical & dental devices industry, molding industry, optical industry, bio-array preparation technology and microfluidics.

### BACKGROUND OF THE INVENTION

In the past 20-30 yeas silane chemistry is one of the highly developing areas of the modern chemical industry applicable to wide areas of the world economy—from fundamental chemistry, chemical catalysis and construction industry to microelectronics and bio-microarray technology. As a result, extremely wide varieties of silane- and carbon-silane chemicals have been produced serving for wide variety of purposes and applications. Many of them are used for the preparation of different types of repellant surfaces, generally—water- or oil-repellant. Variety of patents has been filed to support such discoveries. Nevertheless, the universal approach has been to produce silane-containing compounds including single-type silanes or silane-containing substances exhibiting both—certain desired physical- and chemical properties, and different levels of chemical structure complexity. Thousands of silane compounds have been synthesized and mass-produced for varieties of applications and industries. For example currently almost any sealant or paint product includes cyclic silanes as additives—used as a repellant- or shine-surface contributor—which, however, are (as-is) incapable of creating effective nano-layers as not being capable to chemically cross-react with other, chemically-reactive substances and thereby have been utilized at their lowest-level capabilities. Although this common-type approach of synthesizing silanes with pre-designed (determined) physico-chemical properties had successfully resulted in the global development of silane chemistry and industry, the overall cost of the highly-effective and reactive compounds had limited their utilization in most industries and wide-variety of potential applications. As a result of this invention, producing inexpensive compounds with complex and very efficient properties for use in wide variety of applications and industries is achieved by a novel, very flexible, extremely easy and low-cost approach of combining (mixing) two or more silane-containing chemicals capable of pre- and/or post-reacting with each-other, and/or with the target surfaces upon their final application resulting in the formation of ultra-thin surfacing layers demonstrating extremely fact formation at ambient conditions, strong durability and long preservation of physical properties. This approach of “assembling properties” in situ by combining multiple silane-(alone) and multiple silane- & non-silane chemicals, rather than “designing & chemically synthesizing” specialized chemical substances (silanes), is extremely benefiting from any point of view. The extreme benefits of this substances combinatorial approach are based upon the empirically observed properties of most silane molecules to react randomly and/or according to pre-defined chemical principles (depending upon their chemical groups' substitutions) with various types of molecules and compounds when mixed in solutions—resulting in a determined formation of surfacing polymeric layers with desired properties that are more advanced than if utilizing the originally manufactured compounds alone. This invention describes the methodologies and principles utilized in the combinatorial approach for preparation of ultra-thin surfacing polymeric layers with desired properties with the intention of satisfying specific application-, business-, or industrial requirements.

### BRIEF SUMMARY OF THE INVENTION

The invention describes methodological approach and process for preparation of variable compositions of hydrophobic (water-repellant) two- and multi-component mixtures containing linear halogenated molecular compounds (silanes, siloxanes, silane-carbons, hydrocarbons and their derivatives), cyclic molecular compounds (silanes, siloxanes, silane-carbons, hydrocarbons and their derivatives) in halogenated or non-halogenated forms, and other hydrophobic molecular components (in a form of separate molecular substances or as molecular substitutes within the halogenated silanes and/or the cyclic compound molecules

The essential parts and principles of this invention are:

(1) The approach of mixing more than one chemical compound thereby exploring both—first, the combinatory approach of designing COMBINATIONS of properties in situ rather than chemical design with synthesis of a particular single molecular monomer substances and, second, the combinatory approach of “in situ” (on-the-place) ASSEMBLING of enhanced and novel properties immediately upon combining all the components, and immediately after applying the combinatory mixtures onto the applicable surfaces as minimal and/or significant chemical reaction arrangements occur during both conditions (i.e. the mixing and the surface deposition).

(2) The approach of combining multiple-type halogen-element-substituted monomer chain-molecules containing the both highly hydrophobic (water-repellent) chemical elements—Silicon (Si) and Carbon (C), and the oil-repellent halogen elements (Cl, F, I, Br) and the silicon (Si)—thereby achieving two significant properties: first, the halogen elements are highly (violently) reactive with almost all other chemical elements and substances which makes them the perfect choice for universal polymerization- and surface-bonding agents that in low molecular proportions as used are relatively harmless to both the environment and the attachment surfaces, and, second, the particular choices of compounds with particular number and type of halogen atoms and their positions within the monomer molecular chain allows for designing the following: the density-, the thickness-, the levels of hydrophobicity (water-repellency) and/or oil, and dust repellency, the bonding strength, and other physico-chemical properties of the resulting surfacing layers.

(3) The approach of combining not only the ability of covalent (strongest-possible) attachment bonding to the applicable surfaces via halogen element reaction substitution, but also the very-high adsorption capabilities (properties) of both the silicone (Si) and the carbon (C) atoms, as well as the optical clarity of the silicone-containing layers are desired and can be utilized in designing thin layers for specific applications. The combinatory variations of employing both Si- and C-atomic properties within one- and/or with combining separate monomer substances allows for optimization between the higher optical clarity of the Silicone- and the higher hydrophobicity, but relatively lower optical transparency of the Carbon-containing surface layers.

(4) The approach of utilizing cyclic Silicon- and Carbon-containing monomer substances with relatively low molecular size allows for increasing the density of the hydrophobic layers created combined with the ability to control the thickness of the layers created since the cyclic molecules are more compact in size and less-capable of “branching” when polymerizing and forming the final coating layer; they also facilitate higher molecular and structural rigidness of the resulting thin layers.

(5) The approach of utilizing compounds with prevailing Silicone-atom content rather than carbon-containing led to a remarkable observation of light-channeling properties of the created surface layers that led to a reduced surface light-diffraction observed as optical “disappearance” of light-diffraction from scratches and imperfections on optical lenses as well as microscopically observed micro-fiber-like effects of light channeling allowing for internal illumination of colored microscopic preparations. Therefore many silicone-rich mixtures prepared via the methodological approach described in this invention are applicable in optical and light-cloaking implementations and, possibly, in micro-optical computation devices.

Such methodological approach offers better flexibility for preparation of wide variety of repellant mixtures in achieving high water-repellant (hydrophobic), oil- and dust-repellent surfacing layers with exceptionally high durability and long-lasting (permanent) bonding for specific surface applications and for the preparation of other subsequent types of repellant surfacing solutions and materials such as paints or sealing agents, textiles, fabrics, construction materials and else.

### BRIEF DESCRIPTION OF THE DRAWINGS

In the drawings, which form a part of this specification, are presented the following:

FIG. 1: Schematic representation of the length (size) limitations of the hydrophobic (water-repellent) radical substitutions.

FIG. 2: Example of Silane Polymer Formation Based Upon Hydrolysis Reaction.

FIG. 3: Water-repellant nano-layer formation- and protection test.

FIG. 4: Testing surface repellency on different commercially important materials treated with surfacing mixtures.

FIG. 5: Nanolayer light channeling demonstrated by the internal light-illumination of colored microscopic preparations.

### DETAILED DESCRIPTION OF THE INVENTION

The present invention will be described in further detail herein below.

The invented approach explores the ability of halogen-element-substituted (shortly: “halogen-substituted”) silanes (including, but not limited only to, any alkyl-, aryl-, siloxanes and cyclic-silanes) and carbon-silanes (organosilanes) to form both: poly-condensates carrying repellant chemical groups with other chemicals (silanes, organosilanes, carbohydrates, etc.) and to form violently-fast covalent bonds with almost any surface molecules applied on/to (because of the high reactivity of the halogen atoms) resulting in the formation of 2- or 3-dimensional nano-layers exhibiting water-, oil- and/or dust-repellant properties. The absorption (adherence) capabilities of the Si-atom also contribute to the surface attachment formation. Some examples of halogen-substituted silanes used in a pilot-testing the aspects and principles of the described here invention are: chlorotrimethylsilane, dichlorodimethylsilane, methyltrichlorosilane, dichloro-methylphenylsilane, phenyldichlorosilane, dichlorodiphenylsilane, octadecyltrichlorosilane, 1,7-dichlorooctamethyl-tetrasiloxane, 3,5-dichlorooctamethyltetrasiloxane.

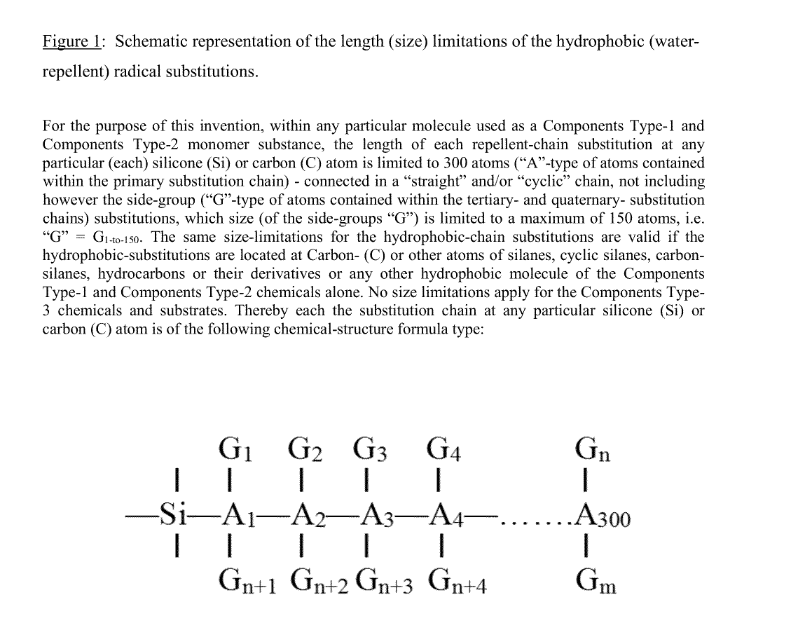

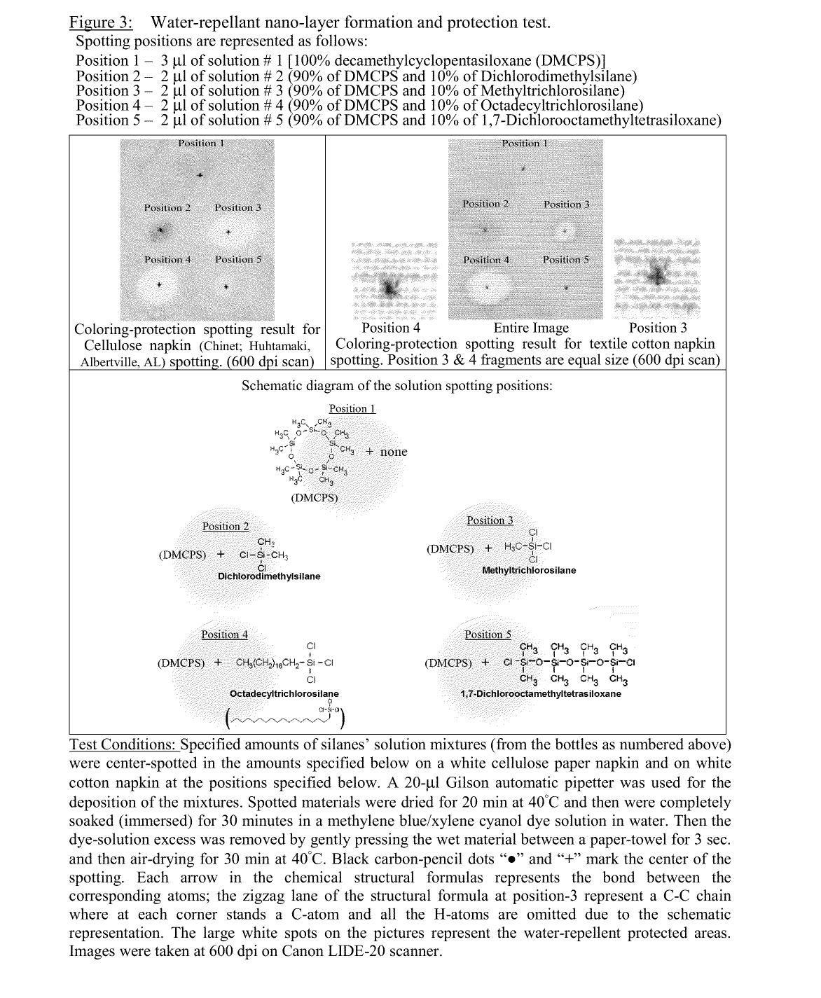

By creating combinatory mixes of halogen-substituted silanes and other silanes, siloxanes, hydrocarbons and else exhibiting repellent properties, highly efficient repellent micro-thin surfaces are produced when the mixtures are deposited as surfacing layer(s). Varying the molecular ratios of the 1-, 2-, 3- or 4-halogen substituted (at a single silicone atom) silanes and the molecular ratios of the halogen element(s) within any particular compound's molecule allows for adjusting the thickness and the density of the created nano-layers—i.e. (in the mixture) the higher the molecular ratios of the halogen-substitutions within the compounds are, the higher is the thickness and the density of the resulting nano-layer formation. Also, the longer the hydrocarbon- (or other hydrophobic-) molecular chains of the substitutions at each silicone (Si) atom is—the higher is the thickness and the density of the resulting nano-layer; respectively—the greater is the hydrophobicity (water-repellency). The simple correlation rule is, that increasing the molecular portion of the carbon increases the ware-repellence but decreases the oil-repellency; on the other hand—increasing the molecular portion of the silicone within a particular compound (or a mixture of compounds) leads to increasing of both the water and the oil-repellency. Increasing the portion of the halogen elements leads not only to increased layer thickness and durability, but also to increased oil-repellency. For the purpose of this invention, the length of each hydrophobic-chain substitution (at a silicone atom) is limited to a maximum 300 atoms [represented by “A” on the FIG. 1]—connected in a “straight” chain, not including side-groups (tertiary-, quaternary-[marked as “G”]); i.e. substitution chains of a type as in the FIG. 1. The size of these chains is of particular significance when hydrophobic (or oil-repellent) properties has to be created on surfaces with large gaps between the structure-supportive materials—the larger the chains of the Si-substitutions are, the larger gaps can be filled-in (see FIG. 3, the cotton napkin image impregnated with surfacing mixtures).

The most important (claim 6) in this invention is the idea of applying the approach of mixing different compositions of silanes and siloxanes (in molecular ratios of mixed chemicals ranging from 0.001% to 99.999% between each-other—prior to their application onto the treated surfaces in order to compose the appropriate repellent properties (depending upon highly- or less-specific surface applications), rather than chemically designing and synthesizing single silane molecular structures alone—in order to employ similar to the above-mentioned repellant properties. This approach allows for great flexibility and significantly reducing the costs in designing and utilizing variations of different applications for variety of surface types. According to the invention, the repellant mixtures composed must contain two or more of the components as follows: Components Type-1—halogen-substituted silane, organosilane or hydrocarbon comprising 1, 2, 3, or 4 halogen atoms (such as F [fluorine], Cl [chlorine], I [iodine] and Br [bromine]) at one-, more- or all silicone (Si) and/or carbon (C) atoms of the halogenated compound molecule—in accordance to the common chemistry principles. For clarification, from one up to four halogen-substitutions are allowed at at-least one silicone and/or carbon atom, however as maximum as all silicon and carbon atoms in a particular halogenated compound molecule could be substituted with halogen atoms as a matter of particular choice according to the general chemistry principles. More than one type of halogenated silanes (molecules) may be used in each particular mixture composition depending upon particular application's requirements. Preferable, but not the only choice are silicone-rich compounds with 2 and 3 or more halogen substitutions per single molecular structure, and at least one hydrophobic-group substitution such as alkyl-, aryl-, or else. The chemical formula for the substituted silanes used as a Components Type-1 is schematically represented by Xₙ—[Si]—Rₘ, where “R” is preferably an alkyl group having from 1 to 300 carbon atoms per R-radical (FIG. 1), such as methyl-, ethyl-, n-propyl-, isopropyl-, n-butyl-, sec-butyl-, decyl-, dodecyl-, tetradecyl-, hexadecyl-, octadecyl-, etc. radicals. Examples of aryl groups represented by R are phenyl- and toloyl radicals. Examples of alicyclic groups represented by “R”, which are free of heteroatoms as constituents of the ring are —(CH₂)₅— and —(CH₂)₄— radicals, and an example of alicyclic groups represented by “R” which have a heteroatom as a constituent of the ring is a —(CH₂)₂—O—(CH₂)₂— radical. The methyl-radical is a preferred example of an alkyl group represented by “R” and the chlorine is a preferred example of the halogen elements represented by “X”; “n” and “m” corresponds to the total number of substitutions containing “n” halogen atoms and “m” hydrocarbons (alkyl-, aryl-, alicyclic- or else groups). “[Sil]” in the formula stands for “silane” in which one or more silicone (Si) atoms are present within the silane molecule and each of them may be substituted; for the purpose of this invention silanes with any chemical structure can be used containing from 1 to 300 silicone atoms within a single silane and/or carbon-silane (organosilane) molecule. Components Type-2—cyclic silane, siloxane, organosilane, hydrocarbon and/or their derivatives with or without halogen-element substitutions. The role of the cyclic molecules is to allow for creating higher nano-layer densities and a preferable layer growth in one dimension (i.e. enhanced 2-dimensional growth—in parallel of the surface applied on) rather than equal growth in all 3 dimensions. Another, Components Type-3, (applicable but not obligatory) also may be employed as been any other chemical substance exhibiting certain hydrophobic molecular properties and/or high affinity to react and substitute a halogen element from the silane molecule; some (but not only) examples of the latest are —H, —OH, C═C, C≡C, Metal-containing molecules and others. As an additional Components Type-3 type are used so-called composite carriers. Preferred nano(micro)-layer composite carriers which are relatively insoluble in the reaction medium are, for example, substances having hydroxyl groups on their surface capable of reacting in a strong manner with the halogenated silanes creating nanolayer composites. Examples of such substances are acidic clays, such as for example Tonsil, montmorillonite and other aluminosilicates in the H⁺-form, zeolites, non- or porous glass (such as, for example, controlled pore glass), non- or porous ceramics (such as controlled pore ceramics), non- or porous silicon dioxide (such as precipitated or pyrogenic silica), non- or porous alumina and non- or porous mullite. Additional examples of preferred carriers which are insoluble in the reaction medium are dried hydrolysis products of functional silanes or polystyrenes, such as, for example, polystyrene which is cross-linked with divinylbenzene. Componets Type-3 could itself be a multi-component mixture.

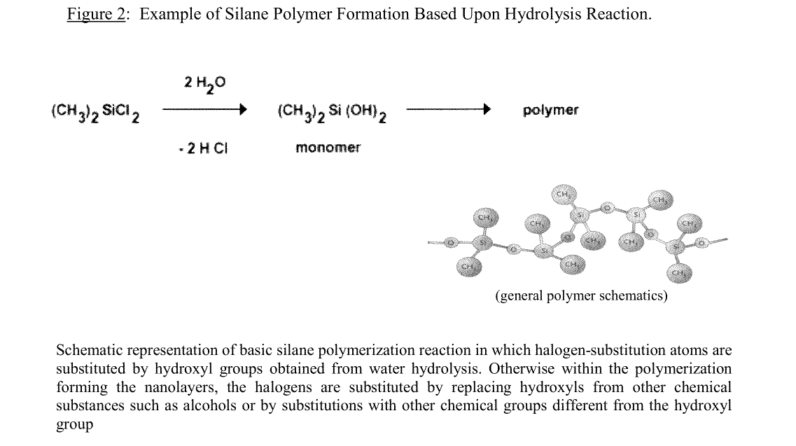

The invention's main core is the process for forming a silicon film on the surface of a substrate comprising the approach of preliminary preparation of multi-component mixes containing at least one halogenated silicone component which serves a highly important feature within the repellent layer when first surface-deposited and contacted with the air-born water humidity and/or water condensation: the spontaneous reaction of the monomeric (organo)halogen-silanes with water molecules or hydroxyl groups (hydrolysis) [i.e. solvent-alcohol(s) or else when used] produces silanols, which, (enhanced by HCl catalysis) lead directly to further reacted oligomers or polymer siloxanes completing the repellant layer formation via directed- (designed-) (FIG. 2) and/or random chemical reactions. This process includes the approach of preliminary (initial) molecular distribution and interactions of the components (the halogenated and the linear or cyclic) in the pre-mixed solutions (mixtures) as well as the absorption (adherence) properties of the Si-atom which all contribute to the surface attachment formation of the nano-layers bearing repellent.

### Chemical Processes Behind the Repellant Nano-Layer Formation

The invented approach of initial pre-treatment preparation of multi-component mixes containing at least one halogenated silicone component serves as a highly important feature (as described) within the repellent layer when first surface-deposited and contacted with the water humidity from natural sources (humidity, rain, etc.): in particular cases, the spontaneous reaction of the monomer (organo)halogen-silanes with water (hydrolysis) [or applicable solvent-alcohol(s)] produces silanols, which, (enhanced by using HCl catalysis) lead directly to further reacted oligomers or polymer siloxanes completing the repellant layer formation (in the picture “Si” represents silicon, “O” stands for oxygen) (FIG. 2). The description “silicones” for the whole class of polysiloxanes is an imitation of the oxygen-carbon bonds of the carbon chemistry which are known as “ketones”. (The latter however, because of their particular characteristics, form double bonds instead of single bonds).

Mono-, di-, tri- or tetra-functional siloxane units with Si—O bonds arise from the polycondensation according to the number of chlorine atoms of the basic silane molecule. In the chemical industry, the diverse halogenated silanes serve as building blocks for the synthesis of the various types of silicones such as fluids, resins and nano-layers.

In our test-experiments, the halogen-substituted alkyl-silanes enable the formation of longer Si—O chains while carrying out hydrophobic or oil-repellent properties (FIG. 3). At first the hydrolysis of, for example, dimethyldichlorosilane gives a mixture of short chained, di-functional and therefore linear siloxanes with OH— and metil groups as well as cyclic siloxanes having normally between three and fifteen chain units. The linear siloxanes show a helix structure with the methyl groups being freely able to rotate. All silicone fluids, emulsions and rubbers are based on dimethyldichlorosilane. This is therefore the decisive base product for the silicone industry. Within our test combinations the halogenated-silane polycondensation interacts with the cyclosilane component in the mixture enhancing the nano-layer formation via direct substitution reactions and/or cyclic concatenation.

If the trichloro-(respectively, tri- or four-halogen-substituted) silane compounds are used, a cross-linking between the linear chains is produced as a result of the three- or four reactive sites of silicon atom. A predominantly three dimensional polymer network is the consequence. In the silicone industry this process is crucial in the formation of silicone resins and thicker dense nano-layers (FIG. 3, positions 3 and 4).

Mono-chlorosilanes, on the other hand, because of their single reactive site, can only be used for the terminating of the chain growth by polycondensation. They react as a sort of “capping agent” for the growing silicone chain. Increasing their relative ration within a composed mixture leads to thinner and low-branched layer formation.

In addition to the simple hydrolysis reaction of halogenated silanes, variations of random halogen-replacement reactions occur in the silane mixtures described in this invention (as commonly known in the Silane Chemistry)—all serving in repellant polymeric layer formation in situ. The particular variation in concentrations (molar ratios) of mono- and multi-halogen silane substitutes, cyclosilanes, hydrocarbons and carbon-silanes (organosilanes) allows for best optimization of nano-layer formation as desired by a specific application's design—by taking into account the molecular reactions variations as a result of the molar ratios variations of the mixture components.

### Preparing and Deploying Proof-of-Concept Testing of Silane Solution Mixes (FIG. 3).

| | | |
|---|---|---|
| Solution #1: | 100% Decamethylcyclopentasiloxane (DMCPS) | [from Oakwood Chemical; Cat. #: S05475] |
| Solution #2: | 90 ml of Decamethylcyclopentasiloxane + | [from Oakwood Chemical; Catalog #: S05475] |
| | 10 ml of Dichlorodimethylsilane | [from Sigma-Aldrich; Catalog #: 440272-100 ml] |
| Solution #3: | 90 ml of Decamethylcyclopentasiloxane + | [from Oakwood Chemical; Catalog #: S05475] |
| | 10 ml of Methyltrichlorosilane | [from Sigma-Aldrich; Catalog #: M85301-100G] |
| Solution #4: | 90 ml of Decamethylcyclopentasiloxane+ | [from Oakwood Chemical; Catalog #: S05475] |
| | 10 ml of Octadecyltrichlorosilane | [from Sigma-Aldrich; Catalog #: 104817-25G] |
| Solution #5: | 90 ml of Decamethylcyclopentasiloxane + | [from Oakwood Chemical; Catalog #: S05475] |
| | 10 ml of 1,7-Dichlorooctamethyltetrasiloxane | [from Sigma-Aldrich; Cat. #: 384372-25G] |

Test Conditions: Specified amounts of silanes' solution mixtures (from the bottled solutions mixes as numbered above) were center-spotted in the amounts specified below on a white cellulose paper napkin and on white cotton napkin at the positions specified on FIG. 3. A 20-μl Gilson automatic pipette was used for the deposition of the solutions. The spotted materials (cotton and cellulose) were dried for 20 min at 40° C. and then were completely soaked (immersed) for 30 minutes in a methylene blue/xylene cyanol dye solution in water. Then the dye-solution excess was removed by gently pressing the wet material between a paper-towel for 3 sec. and then the napkins were air-dried for 30 min at 40° C. A black carbon-pencil dots “” and “+” mark show the center of the spotting (FIG. 3). The large white spots represent the water-repellent protected areas. Images were taken at 600 dpi on Canon LIDE-20 scanner.

### EXPERIMENT CONCLUSIONS

The experimental result shown on FIG. 3 clearly evidences that the ability of triple-halogen-substituted (tri-chloro) silanes to create 3-dimensional nano-layers produces much more significant water-repellant coating (positions 3 and 4 on FIG. 3) compared to the 2-dimensional nano-layer created by the double-halogen-substituted (di-chloro) silanes (positions 2 and 5 on FIG. 3)—while all are correspondingly cross-combined (and cross-linked) with the cyclosilane (decamethylcyclopentasiloxane) in this experiment. Comparing positions 3 and 4 on FIG. 3 demonstrates the influence of the hydrophobic hydrocarbon chain on the water-repellant properties—i.e. the longer the hydrocarbon chain is (position 4 on FIG. 3) the more significant the water-repellant protection is compared to the one demonstrated by a shorter hydrocarbon chain (position 3 on FIG. 3). This is even better visible and distinguished when the air-gaps between the material support are larger (position 3 on the cotton napkin; right-side image on FIG. 3) compared to the smaller gaps (position 3 on the cellulose napkin; left-side image on FIG. 3). The control spot at position 1 on FIG. 3 demonstrates how insignificant (approximately by a 1000-fold) is the hydrophobic protection delivered by the cyclosilane alone compared to all other cases when the cyclosilane is cross-linked to halogen-substituted components—silanes and organosilanes; since the cyclosilane tested here is one of the cyclosilanes used world-wide in amounts of thousands of metric tons per year across different industries, the experiments demonstrates how revolutionary and significant the presented in this invention method is offering improvement of repellent protection of at least 100-1000 times magnitude of better surface protection. Similar results were obtained when only 1% of halogenated components were used instead of 10% as in this experiment—these results support the conclusion that a 1000-fold improvement in repellency protection can be achieved at highly insignificant cost raise that makes this technology as highly economical, as it is effective.

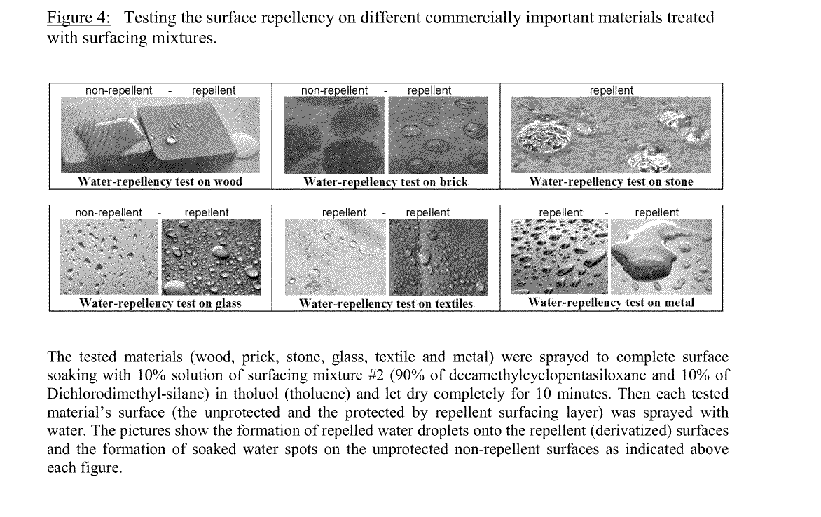

Additional experiments were performed to test the repellency protection on different materials (FIG. 4) and different sizes and weights of particles to test the ultra-layers strength, durability and protection life. Similar results were obtained for oil-repellent surfacing layers which however are difficult to present in picture (especially in black-&-white format) due to the low transparency of the oil impregnation. Tests employing Solution 2 composition on an automobile windshield and Solution 5 composition on automobile wheels demonstrated significant repellent properties remaining after 6 months with still noticeable protection remaining after 2 year from the initial application. In our tests we were unable yet to find any type of surface that is resistant to the application of the variety of layers-forming compositions tested up to date. Also no visible side-effects were detected affecting the visible appearance of the surfaces cured with the ultrathin layers-forming mixtures except in the cases when components with high carbon-content were utilized; in which cases the surfaces exhibit more oily appearance.

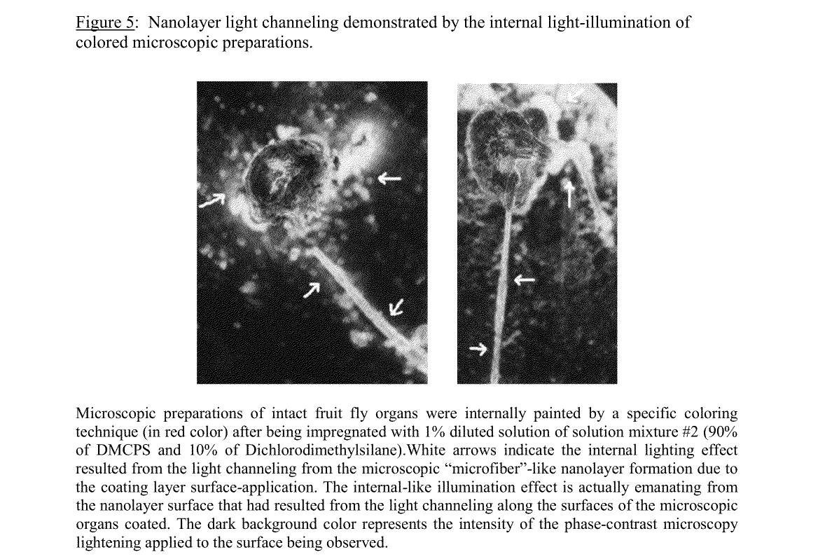

Another types of experiments were performed to test the encapsulation and impregnation capabilities of the surfacing layers including mechanical and biological objects of different nature. Although no detailed measurements on the retention forces strength was performed, we observed significantly high adhesion and retention forces. For example, when Solution composition 1 (as above) was used for the adhesion and attachment of ceramic, glass, wood, plastic, and muscle and brain tissues of a sizes up to 1 cm² and weight up to 1 g (higher parameters were not tested), their retention to a glass slide surface was so strong that a water-get was unable to detach them from the glass surface attached to. Similarly, microscopic insect organs (FIG. 5) and lipid-rich (oily) brain sections of up to 1 mm thickness (that is impossible to retain to a glass surface by the current laboratory means) were attached and impregnated so strongly that only blade-scraping could remove them from the glass surface attached to; 1% diluted solution of solution mixture #2 (90% of DMCPS and 10% of Dichlorodimethylsilane was used). Moreover, the nanolayer surfacing created permitted the observation of light-channeling and light dispersion effects on the surface and in-depth inside the objects when using both light-contrast and fluorescent microsopy (FIG. 5). Finally, after a treatment of glass lenses having scratches, which had generated unpleasant light-refraction effects to the eyes, with Solution 3 (containing methyl-thrichlorosilane), the scratch-refraction disappeared as a result of the nanolayer formation and its light channeling properties.

As described above, this invention includes highly efficient approach for preparation of multi-component repellent mixtures containing an optimized variety of silanes and other repellent molecular components to provide desired properties to the surfaces applied to. It allows for great flexibility in the formation of highly efficient surface-repellant mixtures to specific materials and for variety of applications like windshield treatments and optical lenses coating, and also offers the ability to aid in the preparation of other types of water-, oil- and dust-repellent surfacing products that can be applied to paints or sealing agents, textiles, construction materials, etc. affecting virtually any segment of todays industries.

The prepared surface-repellent solutions and mixtures create an envelope of protection that extends the life of the surface substrates for months and even years in challenging environments. Potential benefits include: excellent water-, oil- and/or dust-repellency, long-term durability, UV stability, high depth of penetration, significant water-vapor and gas permeability and certain liquid permeability, high dilution capability and stability, clear, uniform, neutral appearance, desired nano-layer thickness by employing 2- and 3-dimensional structure and insignificant cost. The benefits of construction protection include: permanent-type of surface bonding, reduced efflorescence, reduced freeze-thaw damage, chloride ion resistance to deter corrosion of reinforcing steel in concrete structures, preservation of aesthetics and best cost-to-effect ratio.

The product lines prepared under this invention can be applied to the following areas: automotive and boat clear coats; windshield treatment; body, interior, wheels; optics-related application such as coating of glass and plastic prescription lenses, precision optics (film lenses, research, photography, projectors) and electronic displays; home-related applications, such as protective coating of electronics, appliances, glass bake ware, tile and bathroom surfaces; commercial applications including treatment and modification of textiles, primers, industrial maintenance, construction materials, interior and exterior building surface applications. The silane-based repellent compositions are available for use in formulations that penetrate a broad range of substrates used in the general construction industry, including: poured-in-place or pre-cast concrete, concrete block, sandstone/granite, brick/tile/grout, wood, gypsum/perlite, limestone/marble and other wide variety of construction materials and surfaces.

While the invention has been described in detail and with reference to specific embodiments thereof, it will be apparent to one skilled in the art that various changes and modifications can be made in particular mixtures definitions for addressing specific applications and surface materials therein without departing from the spirit and scope thereof.

1. Variable water-, oil-, and/or dust-repellent chemical compositions in form of solutions or mixtures for preparation of repellent thin (nano-/micro-) layers, said composition containing combinations of any two or more of the following types components:
Components Type-1—from 0.001% to 99,999% by volume of halogen-substituted silane, siloxane, organosilane (carbon-silane) or hydro-carbon containing 1, 2, 3, or 4 halogen atoms (such as F [fluorine], Cl [chlorine], I [iodine] and Br [bromine]) at any particular single atom of one-, more- or all silicone-(Si) and/or carbon-(C) atoms of the halogenated molecule, i.e. from one up to four halogen-substitutions present at at-least one silicone- or carbon atom of the monomeric molecule, however as maximum as all silicone atoms in a particular halogenated molecule of the Component Type-1 chemical molecule could be substituted with halogen atoms as a matter of particular choice according to the general chemistry principles and depending upon particular applications; the chemical formula for the substituted silanes used as a Components Type-1 is schematically represented by Xₙ[Sil]Rₘ, where “R” is a hydrocarbon group (preferably alkyl-, aryl-, alicyclic- or else), the halogen element is represented by “X”; “n” and “m” corresponds to the total number of substitutions containing “n” halogen atoms and “m” hydrocarbons (alkyl-, aryl-, alicyclic- or else groups) with or without halogen substitutions, “[Sil]” in the formula stands for “silane” (silane, siloxane or carbon-silane) in which one or more silicone (Si) atoms are present within the “silane” molecule and each of them may contain chemical group substitution of the types X₁₋ₜₒ₋₄ and R₁₋ₜₒ₋₄;
Components Type-2—from 0.001% to 99,999% by volume of cyclic-silane, -siloxane, -hydrocarbon and/or their cyclic derivatives—substituted in part, in full or not-substitutes by halogen atom(s) following the same chemical principles as outlined for the Components Type-1;
Components Type-3, (applicable but not obligatory)—from 0.001% to 99,998% by volume of any other chemical or (micro-)particle substance ranging in size from 0.1 nm up to 5 mm exhibiting hydrophobic or oil-repellent properties and/or high affinity to react and substitute a halogen element from silane- and/or organosilane-, or multi-carbon-(containing from 1 to 1000 carbon atoms) molecule(s) comprising but not limited to H—, OH—, —C═C—, —C≡C—, Metal-, S-, azido-containing molecules and composite carriers, of which the preferred nano(micro)-layer composite carriers are relatively insoluble in the reaction medium (including but not limited to substances having hydroxyl groups on their surface capable of reacting in a strong manner with the halogenated components of types 1 and -2 creating thereby nano-(micro-)layer composites comprising acidic clays (as Tonsil, montmorillonite and other aluminosilicates in the H⁺-form, zeolites), non- or porous glass, non- or porous ceramics and silicates, non- or porous silicon dioxide (including but not limited to precipitated or pyrogenic silica), non- or porous alumina and non- or porous mullite, dried hydrolysis products of functional silanes or polystyrenes (including but not limited to polystyrene which is cross-linked with divinylbenzene); the Componets Type-3 could itself be a multi-component mixture containing different chemical substances and impurities.

2. The variable hydrophobic (water-) or oil-repellent chemical compositions of claim 1 in form of solutions or mixtures for preparation of repellent thin (nano-/micro-) layers, said compositions containing combinations of at least one chemical of Components Type 1 and at least one chemical of Components Type 2, or at least 2 chemicals of only Components Type 1, or at least 2 chemicals of only Components Type 2 with the portion of each chemical ranging from 0.001% to 99,995% by the volume of the final solution (mixture) composition.

3. The variable repellent chemical compositions of claim 1, designed and utilized as containing molecular components with prevailing number (above 50%, by atomic type) of silicone atoms and a relatively limited number (below 40%, by atomic type) of Carbon atoms per compound molecule resulting in the formation of thin surfacing layers, which exhibit (demonstrate) as discovered commercially important optical properties after being applied onto the targeted surfaces—high optical clarity and light-channeling properties, since on nanolayer level the light-channeling effect arises from the fact that silicone-rich molecule(s) act as an “optical fiber” and the light can be channeled and/or trapped in ways desired within the particular optical application(s) including but not limited to professional-, personal-optic devices and optical surface-masking effects (i.e. optically modifying or hiding surface colors and imperfections), reduction of light diffraction and optical corrections—including but not limited to making optically small scratches to virtually “disappear” as a result of the molecular light channeling (photons-transport and/or photons-entrapment) effects; the water and/or oil-repellent composition mixtures under this invention are intended for creating desired optical properties on the targeted surfaces—including, but not limited to: cloaking (hiding), light reflection, light channeling, internal and/or external lightening via optical fiber-like effects, light dispersing (shining).

4. The molecular positioning, the type and the total number of halogen atoms within each monomer molecule of Components Type-1 and Components Type-2 of claim 1 are utilized to design the properties of the repellent layer formation as follows:
when containing only a single halogen atom within at least one —Si—Si—, —Si—C— or —C—C— monomer molecule chain, the chemical component within the mixture is used for polymerization “capping” (termination) and for limiting the size of the polymerizing polymer and the thickness of the resulting layer resulting in “two-dimensional” (flat) hydrophobic surfaces since these (single-halogen-substituted) molecules are not able to support significant monomer polymerization;
when containing two halogen atoms within at least one —Si—Si—, —Si—C— or —C—C— monomer compound molecule, the corresponding mixtures (solutions) are designed to facilitate the formation of repellent large-scale 3-dimensional polymerization surfaces with preferred polymerization growth in one dimension—resulting in a larger-area “flat”-type repellent layer with relatively limited layer's surface thickness;
when containing 3 or more halogen atoms within at least one —Si—Si—, —Si—C— or —C—C— monomer molecule, the corresponding mixtures (solutions) are designed to facilitate the formation of repellent large-scale 3-dimensional polymerization surfaces with expanded polymerization growth in all dimensions—limited only by the chemical molecular design and the concentration proportions of the Components-1 and -2, the gravity of the surfacing solution (mixture) and/or the surface- and the capillary tensions between the components, as well as any random factors that may play role in the final hydrophobic surface formation;
alternatively, the utilization of cyclic molecules of monomer compounds (Components Type-2 of claim 1) is to allow for creating higher nano-(micro-)layer densities with enhanced repellent properties, increased layer rigidness and (especially when using cyclic monomer compounds that are non-substituted by halogen atoms) a preferable layer growth in one dimension (enhanced 2-dimensional growth)—in parallel of the surface applied on, rather than equal growth in all 3 dimensions.

5. The Components Type-1 of claim 1, schematically represented by Xₙ—[Sil]-Rₘ, where “R” is a hydrocarbon group (preferably, but not limited to alkyl-, aryl-group, or their derivatives) that comprise a chain of carbon (C—) atoms including from 1 to 200 carbon atoms per R-radical, including but not limited to methyl-, ethyl-, n-propyl-, isopropyl-, n-butyl-, sec-butyl-, decyl-, dodecyl-, tetradecyl-, hexadecyl-, octadecyl-, etc. radicals or their derivatives; aryl groups represented by R are phenyl- and toloyl radicals or else and their derivatives; alicyclic groups represented by “R”, which are free of heteroatoms as constituents of the ring include but are not limited to —(CH₂)₅ and —(CH₂)₄-radicals or their derivatives, and alicyclic groups or their derivatives represented by “R” which have a heteroatom as a constituent of the ring include but are not limited to —(CH₂)₂—O—(CH₂)₂-radical; the methyl-radical is a preferred (but not the only) example of an alkyl group represented by “R”; the silanes groups [Sil] included may have any stearic chemical structure and the usually utilized are these containing from 1 to 300 silicone atoms within a single silane-, siloxane and/or carbon-silane (organosilane) monomer molecule for both Components Type-1 and Components Type-2.

6. A method for assembling water-, oil-, and/or dust-(small particles of sizes from 0.1 nm to 0.3 mm) repellent solutions and mixtures, said method comprising the approach and the process of combining (pre-mixing) at least two of single- or multi-component solutions containing halogenated silanes, siloxanes, organo-silanes, hydrocarbons and derivatives of the above, cyclic molecular compounds (silanes, siloxanes, silane-carbons, hydrocarbons and their derivatives)—halogenated or not, and other monomer-type repellent molecular components (as separate molecular substances or as molecular substitutes within the halogenated silanes and/or the cyclic compound molecules) capable of forming thin nano-(micro-)layers by polymerization as a result of substitution of a halogen atom(s)—the approach and process comprising of combining two or more chemical components rather than utilizing single-type chemical substances alone in a pure- or diluted form, and thereby combining individual reagents properties and also thereby developing novel properties in situ rather than synthesizing individual reagents, which carry all the desired properties;
thus the method process includes the approach of initial molecular distribution and interactions of all the monomer-type components (including those halogenated and cyclic) in the pre-mixes, and the absorption (adherence) capabilities of the Si-atom, which all further contribute to the surface attachment formation of the ultra-thin (nano-)layers bearing repellent properties;
said method and process utilize both random and spontaneous reactions of the combined monomeric molecular substances with the halogen-substituted substances, and with water (hydrolysis) from solvents and/or air humidity [and/or solvent-alcohol(s) when used] resulting in variety of chemical products some of which produce silanols, which, using or not acids (HCl and/or else) catalysis, lead directly to further reacted oligomers or polymer siloxanes completing the repellant layer formation via directed- (designed-) and/or random chemical reactions that finally results in two- or three-dimensional formation of ultra-thin repellent layers upon the surface-application of the final mixtures (pre-mixed solutions);
such methodological approach comprises highest flexibility for repellant mixtures preparation in achieving high repellant properties of the resulting layers for satisfying the requirements of specific surface applications and for the preparation of other subsequent types of repellant surfacing solutions such as paints, finishes or sealing agents, repellent textiles, construction materials and else;
said method and process for making a film-forming hydrolytically reactive silyl-group-containing oligomeric compound mixtures that are suitable for use in a sprayable coating compositions are comprising the following steps:
mixing two or more chemical compounds of the type-1, and/or type-2 and/or type-3,
storing the stock-mixtures,
dissolving or not the concentrated mixtures in any appropriate (non-volatile) organic solvents,
contact deposition of the concentrated or dissolved mixtures onto target surface(s) by the means of spraying, over-laying, submerging, passing through, brushing, wiping, soaking,
spontaneous and instant thin layer formation as a result of hydrolytic reaction between the molecules of the mixture components aided by the humidity (existing water molecules) from the surrounding air or liquids.

7. The method and process for assembling repellent solutions and mixtures of claim 6 that includes the approach of adjusting the design of the finally formed repellent layer in fulfilling specific surface-properties and the method's flexibility in adjusting to specific applications is achieved by varying the chemical type-, the total number, and the molecular proportions of the combined monomeric compounds within the pre-assembled solutions (mixtures)—by creating optimized variety of combinatory mixes of halogen-substituted substances with other silanes, siloxanes, hydrocarbons, carbon-silanes and another organic and/or inorganic compounds exhibiting repellent properties in which both types commercially available- and specifically-synthesized monomer compounds are used—when the solutions (mixtures) are deposited as surfacing layer(s), highly efficient repellent thin surfacing layers are produced.

8. The method for assembling repellent solutions and mixtures of claim 6 is performed preferably at ambient values of temperatures, visible-light or dark-light conditions and ambient or enhanced atmosphere humidity since the method is relatively tolerant to the process conditions; however, due to the very-high chemical reactivity of the halogen-element-substituted chemical compounds, the preferences for these ambient conditions (nevertheless—without imposing any condition limitations) are to be at their low-energy levels as the following: temperatures from −30° C. to 50° C.; lighting within the infrared light spectrum or visible light of above 450 nm wave-length with low luminosity (as to permit human visibility); atmospheric air composition, preferably with low oxygen- and high argon content; lowest possible atmosphere humidity, preferably below 30%; otherwise the high-range values of the above condition parameters are preferable after the surface application of the composed mixtures is carried out—because the surface-formation of the repellent layer and the layer's attachment to the target-surface is enhanced at higher temperatures (up to 500° C.), light within the UV spectrum (200-450 nm) with moderate luminosity or high luminosity for short exposure time (not increasing 10 minutes), and high air humidity with water molecules present up to 90% (v/v).

9. The method and the process for assembling repellent solutions and mixtures of claim 1 and claim 6 is intended for surface attachment, encapsulation and/or impregnation by the means of a formation of liquid-repellant nano-(micro-)layers as a result of molecular cross-linking between the components of the repellent solution mixtures (silicone-, siloxane, carbon-silicone and hydrocarbon compounds—halogenated or not) and the surface(s)' components (molecules) involved—thereby the composition mixtures under this invention are also intended for usage for microencapsulation, and/or impregnation of small objects of mechanical nature (ranging from 0.1 ng to 2 g per 1 cm²), and/or for their attachment to surfaces by the means of encapsulation, impregnation and/or the binding resulting from the silicone nano-(micro-) layers formed, and the chemical and adsorption bonding facilitated by (during) the formation of the polymeric thin layers.

10. The method for assembling repellent solutions and mixtures of claim 1 and claim 6 includes the approach and the process of varying the molecular ratios of the 1-, 2-, 3- or 4-halogen substituted (at any single silicone or carbon atom) silanes, siloxanes, carbon-silanes and hydrocarbons (with linear or cyclic molecules) within each particular repellent solution (mixture) composed, which (varying of the molecular ratios) serves for relatively adjusting the thickness and the density of the created nano-(micro-)layers—the higher the molecular ratios of the halogen-substitutions of the atoms and the chemical substances within the mixture are, the bigger are the thickness and the density of the resulting nano-(micro-)layer formed; the longer the hydrocarbon- (or other hydrophobic-) molecular chains of the substitutions at each silicone (Si) and Carbon (C) atom are—the higher are the thickness and the density of the resulting nanolayer, and, respectively, the greater is the hydrophobicity (water-repellency); alternatively—the higher are the molecular ratios of both the halogen and the silicon (Si) atoms within the components' molecules, and the smaller is the molecular ratio of the carbon atoms within the components' molecules, the higher is the demonstrated oil repellency of the resulting layer.
